(19) United States
(12) Patent Application Publication
(10) Pub. No.: US 2026/0279658 A1
(43) Pub. Date: Sep. 17, 2026

(54) COIL COMPONENT

(71) Applicants: TAMURA CORPORATION, Tokyo (JP); TAMURA CORPORATION OF CHINA LIMITED, Shanghai (CN)

(72) Inventors: Junji KONDO, Saitama (JP); Zhiyong LIANG, Shanghai (CN); Xiaoming YANG, Shanghai (CN); Jinwei LIN, Shanghai (CN)

(73) Assignees: TAMURA CORPORATION, Tokyo (JP); TAMURA CORPORATION OF CHINA LIMITED, Shanghai (CN)

(21) Appl. No.: 19/562,733

(22) Filed: Mar. 10, 2026

(30) Foreign Application Priority Data
Mar. 14, 2025 (CN) 202510304423.0

(51) Int. Cl. H01F 27/32; H01F 27/06

(52) U.S. Cl. CPC H01F 27/32; H01F 27/06

(57) ABSTRACT

A coil component is provided. The coil component includes: a coil formed by connecting multiple U-shaped members and I-shaped members each having a thickness of 5 mm or more; a mounting bracket made of a metal member and fixing the coil component to an installation target surface; and an insulating member disposed between the coil and the mounting bracket. The U-shaped members and the I-shaped members are not covered around their peripheries with an insulating coating, and a fitting hole is formed in the mounting bracket. The insulating member includes: coil supporting portions into which respective turns of the coil are inserted and which fit with the respective turns, and a protruding portion that fits in the fitting hole and fixes the insulating member to the mounting bracket.

### CROSS-REFERENCE TO RELATED APPLICATION

This application is based upon and claims the benefit of priority from Chinese Patent Application No. 202510304423.0, filed on March 14, 2025, and the entire contents of which are incorporated herein by reference.

### FIELD OF INVENTION

The present disclosure relates to a coil component.

### BACKGROUND

Coil components are, for example, reactors and transformers, and are used in power supply circuits of various electronic devices such as OA equipment, solar power generation systems, vehicles, and chargers. A reactor is an electromagnetic component that converts electric energy into magnetic energy for accumulation and release. A transformer is an electronic component that converts voltage level of AC power using electromagnetic induction.

A coil component includes a core and a coil. When electric power is supplied to the coil, the coil generates magnetic flux. The core is made of a magnetic material, and lets the magnetic flux generated by the coil pass through it. The coil component includes a mounting bracket, in order to fix the coil component to an installation target object. The mounting bracket is a metal member, and is disposed below the coil.

A large current of 500 A may be passed through the coil component. Therefore, the coil component is required to maintain insulation between the coil and the mounting bracket even when a large current flows. Also, since a large current flows through the coil, a flat rectangular wire having a thickness of about 1mm cannot be used; thus, the coil is formed by connecting conductive members. Since the conductive members are not covered with an insulating coating, insulation between turns is required.

### SUMMARY OF INVENTION

The present disclosure is achieved to address the above-described problem, and the present disclosure provides a coil component that ensures insulation between the coil and the mounting bracket and insulation between the turns of the coil.

A coil component of the present disclosure includes: a coil formed by connecting a plurality of conductive members each having a thickness of 5 mm or more; a mounting bracket made of a metal member and fixing the coil component to an installation target surface; and an insulating member disposed between the coil and the mounting bracket, in which the plurality of conductive members are not covered around their peripheries with an insulating coating, the mounting bracket has a fitting hole formed therein, and the insulating member includes: a coil supporting portion into which each turn of the coil is inserted and that fits with each turn; and a protruding portion that fits into the fitting hole and fixes the insulating member to the mounting bracket.

According to the present disclosure, it is possible to obtain a coil component that ensures insulation between the coil and the mounting bracket and insulation between the turns of the coil.

### BRIEF DESCRIPTION OF DRAWINGS

FIG. 1 is a perspective view illustrating the main configuration of a coil component.

FIG. 2 is an exploded perspective view of the coil component.

FIG. 3 is a perspective view illustrating a state in which the core is covered with a core case.

FIG. 4 is an exploded perspective view of the core case.

FIG. 5 is a perspective view illustrating an entire configuration of the coil component.

FIG. 6 is a perspective view of a mounting bracket.

FIG. 7 is a view illustrating an arrangement in which the coil component is fixed to an installation target object.

FIG. 8 is a perspective view of a fixing bracket.

FIG. 9 is a perspective view of an insulating member.

FIG. 10 is a perspective view of the insulating member as seen from the bottom surface.

FIG. 11 is a perspective view of a resin cover as seen from the bottom surface.

### DETAILED DESCRIPTION OF THE EMBODIMENTS

### Embodiment

A coil component according to an embodiment will be described with reference to the figures. In each drawing, for ease of understanding, there are cases where thickness, dimensions, positional relationships, ratios, shapes, etc. may be emphasized, and the present disclosure is not limited thereto.

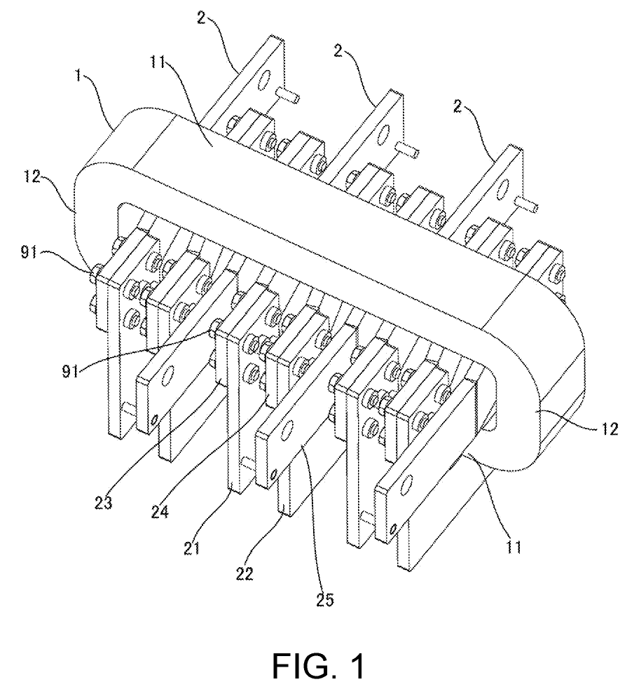

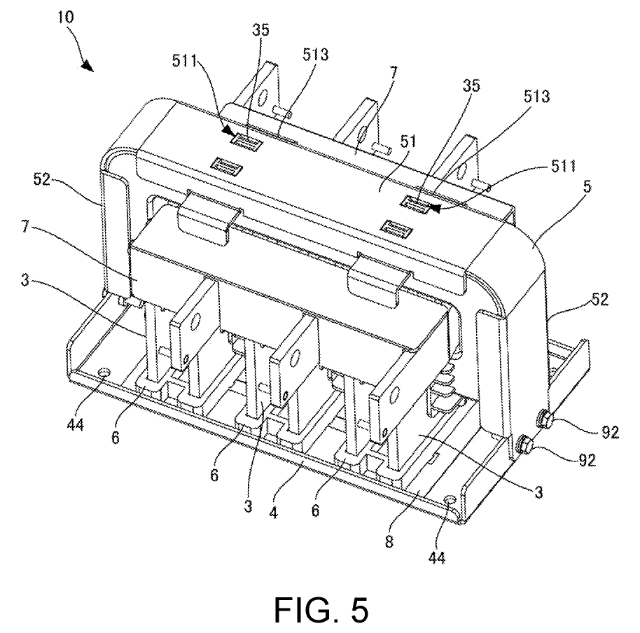

FIG. 1 is a perspective view illustrating the main configuration of the coil component. The coil component 10 (see FIG. 5) is used as an electronic device such as a reactor or a transformer. A large current of 500 A or more, for example, 1,000 A, is passed through the coil component. The coil component 10 includes a core 1 and a coil 2 as illustrated in FIG. 1.

A dust core, a ferrite core, a laminated steel plate, a metal composite core, or the like can be used for the core 1. The metal composite core is a magnetic body formed by kneading magnetic powder and resin, and curing the resin.

The core 1 includes a pair of leg portions 11 and a pair of yoke portions 12. The leg portions 11 extend linearly in parallel with the winding axis of the coil 2. The pair of leg portions 11 is arranged side by side such that their extending directions are parallel. The yoke portions 12 connect the pair of leg portions 11, and the core 1 has an annular shape.

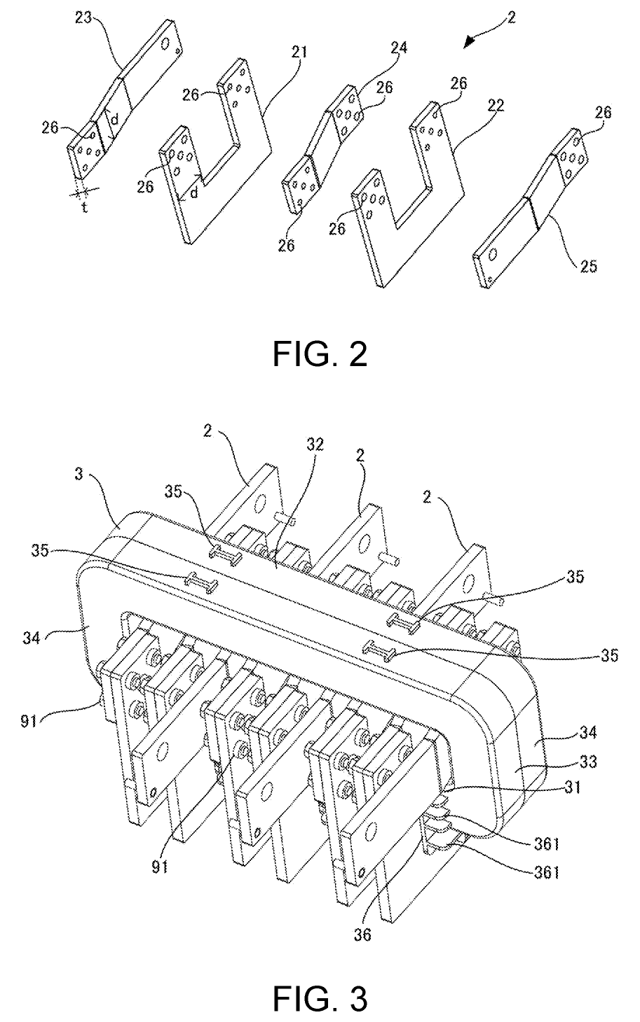

Three coils 2 are provided, and are attached to one of the leg portions 11. FIG. 2 is an exploded perspective view of the coil 2. The coil 2 is formed by U-shaped members 21 and 22 and I-shaped members 23, 24, and 25. The U-shaped members 21 and 22 and the I-shaped members 23, 24, and 25 are made of a conductive member such as a copper plate. The U-shaped members 21 and 22 and the I-shaped members 23, 24, and 25 are plate-shaped members. The outer surfaces of the U-shaped members 21 and 22 and the I-shaped members 23, 24, and 25 are not covered with an insulating coating such as enamel.

The U-shaped members 21 and 22 and the I-shaped members 23, 24, and 25 have a thickness t of at least 5mm because a large current of 500 A or more flows therethrough. In the present embodiment, the thickness t of the U-shaped members 21 and 22 and the I-shaped members 23, 24, and 25 is 8mm. Also, the U-shaped members 21 and 22 and the I-shaped members 23, 24, and 25 have a width d of at least twice the thickness t of the U-shaped members 21 and 22 and the I-shaped members 23, 24, and 25 because a large current of 500 A or more flows therethrough. In the present embodiment, the width d of the U-shaped members 21 and 22 and the I-shaped members 23, 24, and 25 is 42mm.

The U-shaped members 21 and 22 and the I-shaped members 23, 24, and 25 are arranged such that the U-shaped members 21 and 22 are interposed between the I-shaped members 23, 24, and 25. That is, as viewed from one side in the winding-axis direction, the I-shaped member 23, the U-shaped member 21, the I-shaped member 24, the U-shaped member 22, and the I-shaped member 25 are sequentially arranged. Note that the U-shaped members 21 and 22 have the same shape and size, and the I-shaped members 23 and 25 also have the same shape and size.

Fastening portions 26 are formed in the U-shaped members 21 and 22 and the I-shaped members 23, 24, and 25. The fastening portions 26 are holes. As shown in FIG. 1, the fastening portions 26 of adjacent U-shaped members 21 and 22 and I-shaped members 23, 24, and 25 are overlapped and fastened by a fastener 91 such as a bolt, whereby the adjacent U-shaped members 21 and 22 and I-shaped members 23, 24, and 25 are connected and fixed. Thus, the coil 2 is formed such that one turn is formed by a plurality of conductive members.

As for how to mount the coil 2, first, the core 1 is housed in a core case 3 described later. The I-shaped member 23 is inserted into the inside of the annular core 1 housed in the core case 3. Then, the leg portion 11 of the core 1 is inserted into the inside of the U-shaped member 21, the fastening portion 26 of the I-shaped member 23 and the fastening portion 26 of the U-shaped member 21 are overlapped and fastened together by a fastener 91. After the fastening is completed, the I-shaped member 24 is inserted into the inside of the core 1, and the U-shaped member 21 and the I-shaped member 24 are fastened by the fastener 91. By repeating this also for the U-shaped member 22 and the I-shaped member 25, the coil 2 is formed, and the coil 2 is mounted on the leg portion 11 of the core 1.

FIG. 3 is a perspective view illustrating a state in which the core 1 is covered with a core case 3. The coil component 10 includes the core case 3 as illustrated in FIG. 3. The core case 3 is made of resin, and the type of resin may be, for example, epoxy resin, unsaturated polyester resin, urethane resin, BMC (Bulk Molding Compound), PPS (Polyphenylene Sulfide), PBT (Polybutylene Terephthalate), and compositions thereof. As the resin of the core case 3, for example, a thermosetting resin such as a phenolic resin may be used. Note that thermally conductive filler may be mixed with the resin.

The core case 3 is interposed between the core 1 and the coil 2 and insulates the core 1 from the coil 2. Therefore, it is sufficient that the core case 3 covers the periphery of the core 1 on which the coil 2 is mounted. In the present embodiment, the core case 3 covers the entire periphery of the core 1. That is, the core case 3 includes leg covering portions 31 and 32 and yoke covering portions 33 and 34.

The leg covering portion 31 covers the leg portion 11 on which the coil 2 is mounted. The leg covering portion 32 covers the leg portion 11 on which the coil is not mounted. The yoke covering portions 33 and 34 cover the pair of yoke portions 12, respectively. The leg covering portion 31 insulates the core 1 from the coil 2, and the leg covering portion 32 and the yoke covering portions 33 and 34 insulate the fixing bracket 5 described later from the core 1.

The core case 3 includes positioning portions 35. The positioning portions 35 are provided on an outer peripheral surface of the leg covering portion 32. The outer peripheral surface of the leg covering portion 32 is a surface opposite to a surface (an inner peripheral surface) of the leg covering portion 32 that faces the leg covering portion 31. The positioning portions 35 protrude from the leg covering portion 32. The positioning portions 35 are inserted into a positioning hole 511 of the fixing bracket 5 described later. As viewed from above, the positioning portions 35 protrude in a substantially H shape. Four positioning portions 35 are provided. Note that the vertical direction refers to a direction orthogonal to a wide surface of the mounting bracket 4 described later, and, when the mounting bracket 4 is fixed to an installation target surface, a direction toward the installation target surface is referred to as downward and a direction away from the installation target surface is referred to as upward.

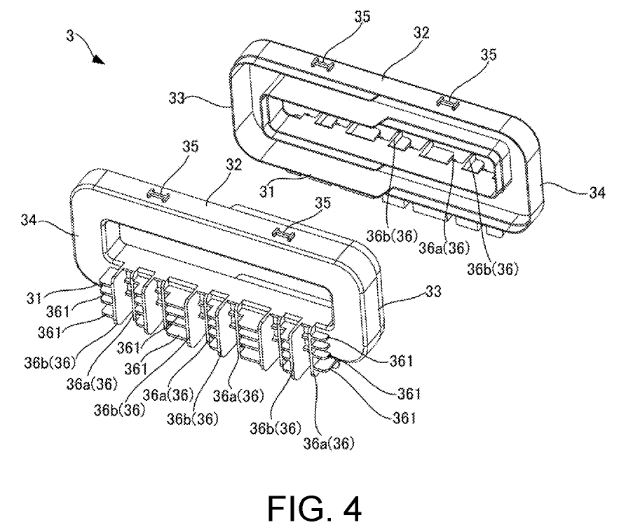

FIG. 4 is an exploded perspective view of the core case 3. As shown in FIG. 4, the core case 3 is divided into two parts. The core case 3 accommodates the core 1 therein. Note that the core case 3 may be formed around the core 1 by molding.

The core case 3 includes a plurality of ribs 36. The ribs 36 are provided on an annular surface of the leg covering portion 31 on which the coil 2 is mounted (i.e., an annular surface of the core case 3). The ribs 36 extend downward from an upper end of the leg covering portion 31. The ribs 36 include ribs 36a having a long protruding length and ribs 36b having a protruding length shorter than that of the ribs 36a. The ribs 36a and the ribs 36b are provided in the same number and are alternately arranged. A rib 36a and a rib 36b form one set, and between the rib 36a and the rib 36b, each turn of the coil 2, more specifically, the U-shaped member 21 or the U-shaped member 22, is disposed. Note that, when the ribs 36a and the ribs 36b are not distinguished from each other, they are referred to as ribs 36.

A spacing between adjacent ribs 36a and 36b is substantially the same as the thickness of the coil 2, that is, the thickness t of the U-shaped members 21 and 22, or is slightly larger than the thickness t. The ribs 36a and 36b may be bonded to the U-shaped members 21 and 22 with an adhesive or the like.

The rib 36 includes reinforcing portions 361. The reinforcing portions 361 extend from a side surface of the rib 36 in parallel with the winding-axis direction of the coil 2. That is, the reinforcing portions 361 extend in a direction orthogonal to an extending direction of the rib 36. A plurality of reinforcing portions 361 are provided for each rib 36.

FIG. 5 is a perspective view illustrating an entire configuration of the coil component 10. As shown in FIG. 5, the coil component 10 includes a mounting bracket 4, a fixing bracket 5, an insulating member 6, and a resin cover 7.

The mounting bracket 4 is a member for fixing the coil component 10 to an installation target surface. The mounting bracket 4 is formed of a metal member such as aluminum. The mounting bracket 4 has a flat plate shape.

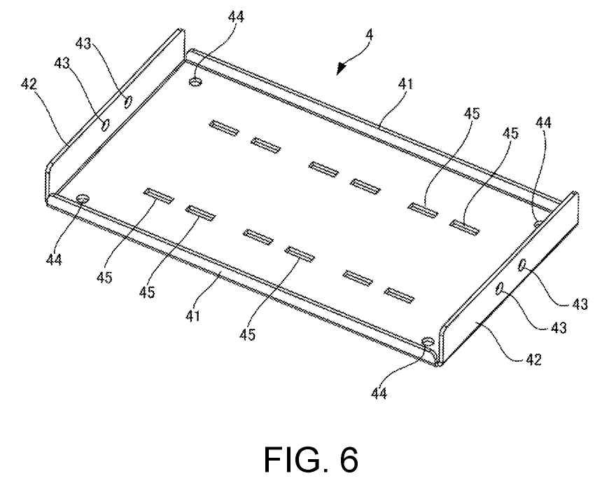

FIG. 6 is a perspective view of the mounting bracket 4. The mounting bracket 4 includes long side walls 41, short side walls 42, fixing portions 43, fixing portions 44, and fitting holes 45. The long side walls 41 rise upward from long sides of the mounting bracket 4. The short side walls 42 rise upward from short sides of the mounting bracket 4. A rising height of the short side walls 42 is higher than that of the long side walls 41. The fixing portions 43, which are holes, are formed in the short side walls 42. Two fixing portions 43 are provided at a central portion of each short side wall 42. The fixing portions 43 fix the fixing bracket 5.

The fixing portions 44 are holes for fixing the coil component 10 to the installation target surface. By inserting fasteners such as a bolt into the fixing portions 44 and fastening the fasteners, the coil component 10 is fixed to the installation target surface. Four fixing portions 44 are provided. The four fixing portions 44 are provided at respective four corners of the mounting bracket 4.

The fitting holes 45 are holes formed in a wide surface of the mounting bracket 4. A protruding portion 63 of the insulating member 6 is inserted into the fitting hole 45. A size of the fitting hole 45 is the same as a size of the protruding portion 63 of the insulating member 6. The number of fitting holes 45 only needs to be such that the insulating member 6 can be fixed.

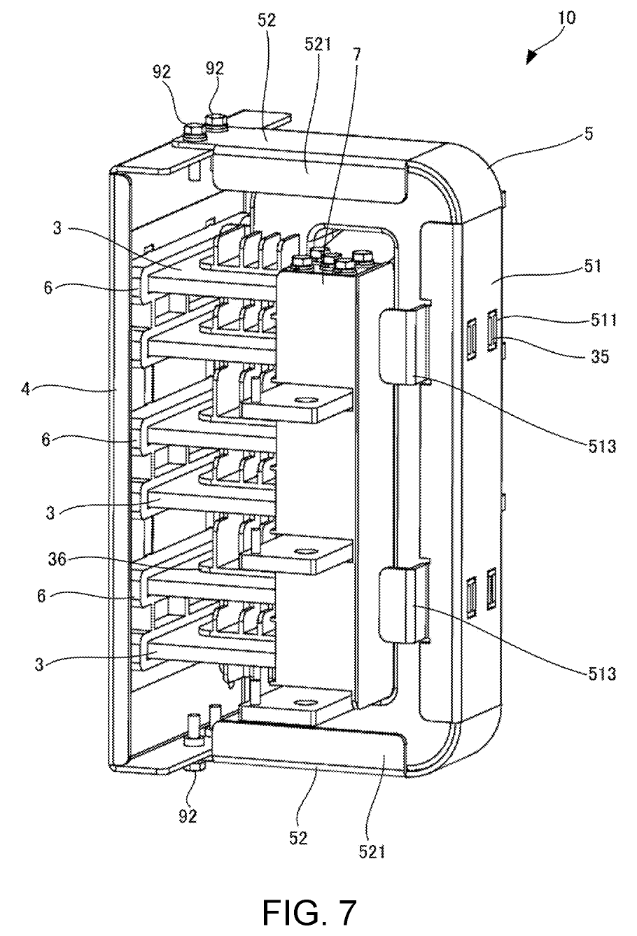

FIG. 7 is a view illustrating an arrangement in which the coil component 10 is fixed to an installation target surface. An installation target surface of the coil component 10 of the present embodiment is a wall extending in parallel with gravity. That is, the coil component 10 is installed such that the winding-axis direction of the coil 2 is parallel with gravity.

The fixing bracket 5 is formed of a metal member such as aluminum. As shown in FIG. 5, the fixing bracket 5 covers the periphery of the core case 3. The fixing bracket 5 includes a leg covering portion 51 and a pair of yoke covering portions 52. The leg covering portion 51 and the pair of yoke covering portions 52 have a flat plate shape. The yoke covering portion 52 extends from both ends of the leg covering portion 51, and the fixing bracket 5 has a substantially U shape. The leg covering portion 51 covers the leg portion 11 that is covered by the leg covering portion 32 of the core case 3. The yoke covering portions 52 cover the yoke portions 12 that are covered by the yoke covering portions 33 and 34 of the core case 3, respectively.

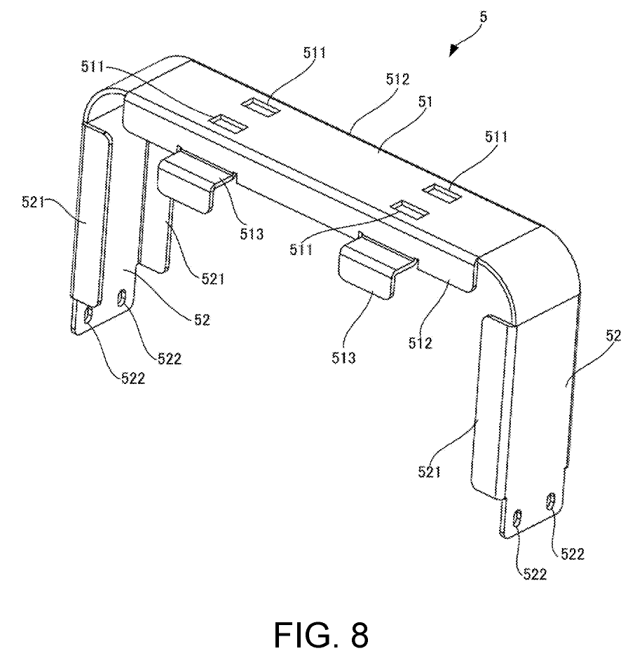

FIG. 8 is a perspective view of a fixing bracket 5. As shown in FIG. 8, positioning holes 511 are formed in the leg covering portion 51. The positioning portion 35 of the core case 3 is inserted into the positioning hole 511. In addition, extending portions 512 and protruding portions 513 are formed on the leg covering portion 51. The extending portion 512 extends from the leg covering portion 51 toward the leg portion 11 of the core 1. The extending portion 512 extends from respective long sides of the leg covering portion 51, and the leg portion 11 is disposed between the pair of extending portions 512.

The protruding portions 513 protrude from a lower end of the extending portions 512. The protruding portion 513 extends from the lower end of the extending portion 512 so as to be orthogonal to the extending portion 512 and is bent by 90 degrees downward. Then, a bent tip end of the protruding portion 513 is in contact with the resin cover 7 (see FIG. 5).

Extending portions 521 and fixing portions 522 are formed on the yoke covering portion 52. The extending portion 521 extends from the yoke covering portion 52 toward the yoke portion 12 of the core 1. The extending portion 521 extends from respective both ends of the yoke covering portion 52, and the yoke portion 12 is disposed between the pair of the extending portions 521.

The fixing portion 522 is provided at a lower end of the yoke covering portion 52. Two fixing portions 522 are provided on each yoke covering portion 52. The fixing portion 522 is a hole and overlaps the fixing portion 43 of the mounting bracket 4. With the fixing portion 522 of the fixing bracket 5 and the fixing portion 43 of the mounting bracket 4 overlapping each other, the portions are fastened together by a fastener 92 (see FIG. 5), and the fixing bracket 5 is fixed to the mounting bracket 4.

The insulating member 6 is made of resin, and the type of resin may be, for example, epoxy resin, unsaturated polyester resin, urethane resin, BMC (Bulk Molding Compound), PPS (Polyphenylene Sulfide), PBT (Polybutylene Terephthalate), and compositions thereof. As the resin of the insulating member 6, for example, a thermosetting resin such as a phenolic resin may be used.

As shown in FIG. 5, the insulating member 6 is provided between the coil 2 and the mounting bracket 4. Three insulating members 6 are provided and are provided below the respective coils 2. The three insulating members 6 have the same shape and size. The insulating member 6 insulates the coil 2 from the mounting bracket 4.

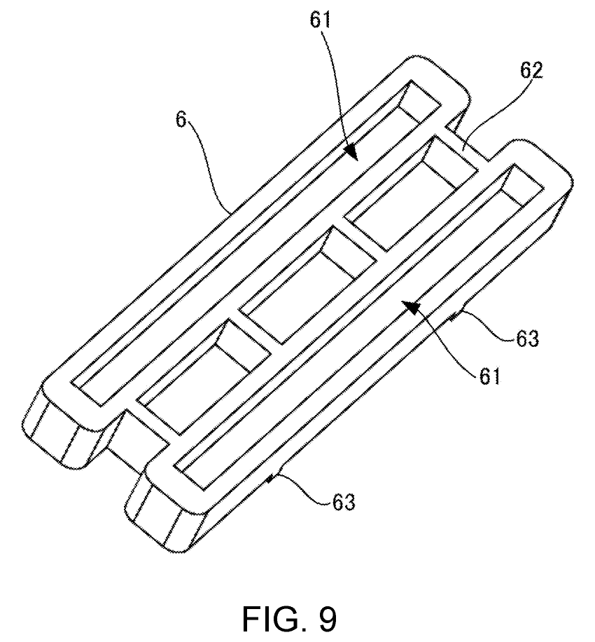

FIG. 9 is a perspective view of an insulating member 6. As shown in FIG. 9, the insulating member 6 includes coil supporting portions 61 and a connecting portion 62. The coil supporting portion 61 is a groove into which the coil 2 is fitted. Each turn of the coil 2 is inserted into the coil supporting portion 61. A size of the coil supporting portion 61 is such that one side of a turn of the coil 2 is fitted therein. Two coil supporting portions 61 are formed in the insulating member 6. The connecting portion 62 is provided between the two coil supporting portions 61. The connecting portion 62 connects the two coil supporting portions 61.

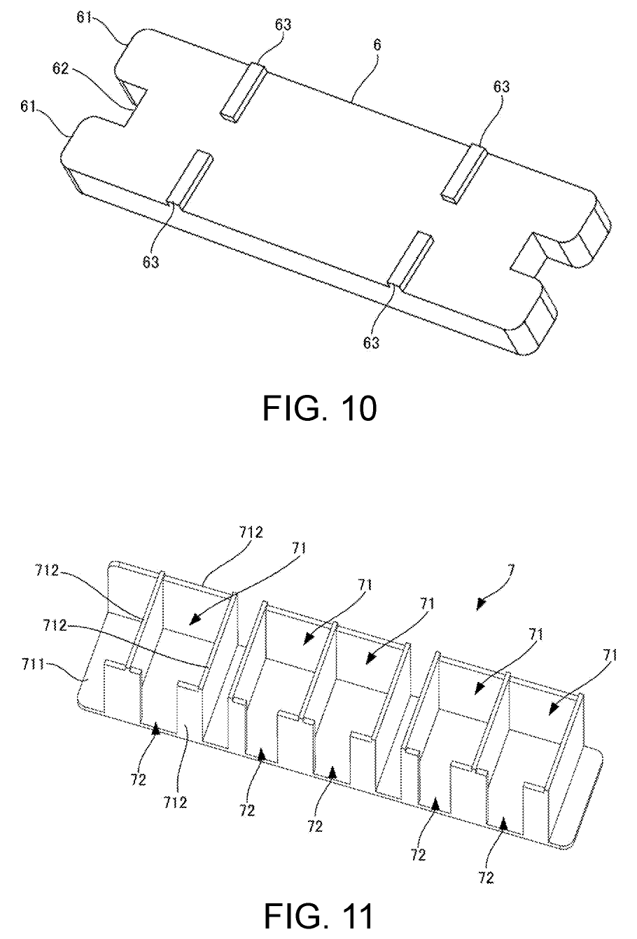

FIG. 10 is a perspective view of the insulating member 6 as seen from the bottom surface. A bottom surface of the insulating member 6 is a surface of the insulating member 6 that is in contact with the mounting bracket 4. As shown in FIG. 10, the insulating member 6 includes protruding portions 63. The protruding portion 63 protrudes from the bottom surface of the insulating member 6. The protruding portion 63 is provided at a position corresponding to the fitting hole 45 of the mounting bracket 4, and the protruding portion 63 is inserted into the fitting hole 45. A length of the protruding portion 63 is shorter than a depth of the fitting hole 45. Therefore, even when the protruding portion 63 is inserted into the fitting hole 45, the protruding portion 63 does not protrude from the fitting hole 45.

The resin cover 7 is made of resin, and the type of resin may be, for example, epoxy resin, unsaturated polyester resin, urethane resin, BMC (Bulk Molding Compound), PPS (Polyphenylene Sulfide), PBT (Polybutylene Terephthalate), and compositions thereof. As the resin of the resin cover 7, for example, a thermosetting resin such as a phenolic resin may be used.

The resin cover 7 surrounds peripheries of the fastening portions 26 of the U-shaped members 21 and 22 and the I-shaped members 23, 24, and 25 that form the coil 2. FIG. 11 is a perspective view of the resin cover 7 as seen from the bottom surface. The resin cover 7 includes a fastening-portion accommodating spaces 71 and a coil insertion openings 72. The fastening-portion accommodating space 71 is a space for accommodating the fastening portion 26. The fastening-portion accommodating space 71 is a space defined by a top plate 711 and four wall portions 712. In the fastening-portion accommodating space 71, the fastening portions 26 of the U-shaped members 21 and 22 and the fastening portions 26 of the I-shaped members 23, 24, and 25 are accommodated one by one. That is, one connection portion between the U-shaped member 21 or 22 and the I-shaped member 23, 24, or 25 is accommodated in the fastening-portion accommodating space 71, and the fastening-portion accommodating space 71 surrounds each connection portion.

The coil insertion opening 72 is formed in a wall portion 712 facing the annular surface of the core 1. The coil 2 is inserted through the coil insertion opening 72. More specifically, one of the I-shaped members 23, 24, and 25 is inserted through the coil insertion opening 72. A size of the coil insertion opening 72 is substantially the same as the thickness t of the I-shaped members 23, 24, and 25, and it is preferable that the I-shaped member 23, 24, or 25 is fitted in the coil insertion opening 72.

Note that, as shown in FIG. 5, an insulating sheet 8 may be provided between the insulating member 6 and the mounting bracket 4. By providing the insulating sheet 8, even if a crack or the like occurs in the insulating member 6, it is possible to ensure insulation between the coil 2 and the mounting bracket 4.

### Effect

As described above, the coil component 10 of the present embodiment includes a coil 2 formed by connecting a plurality of U-shaped members 21 and 22 and I-shaped members 23, 24, and 25 each having a thickness of 5 mm or more, a mounting bracket 4 made of a metal member and fixing the coil component 10 to an installation target surface, and an insulating member 6 disposed between the coil 2 and the mounting bracket 4. The U-shaped members 21 and 22 and the I-shaped members 23, 24, and 25 are not covered around their peripheries with an insulating coating, and a fitting hole 45 is formed in the mounting bracket 4. The insulating member 6 includes coil supporting portions 61 into which respective turns of the coil 2 are inserted and which fit with the respective turns, and a protruding portion 63 that fits in the fitting hole 45 and fixes the insulating member 6 to the mounting bracket 4.

In this manner, insulation between the coil 2 and the mounting bracket 4 can be ensured by the insulating member 6. Also, the U-shaped members 21 and 22 and the I-shaped members 23, 24, and 25 are not covered with an insulating coating at their peripheries. Therefore, it is necessary to ensure an insulation distance between the turns of the coil 2. Then, the insulating member 6 that insulates the coil 2 from the mounting bracket 4 is fitted to and fixed to the mounting bracket 4 and also includes coil supporting portions 61 that fit with the coil 2. Therefore, each turn of the coil 2 is supported by the coil supporting portions 61, and even if the coil component 10 vibrates, the positions of the turns of the coil 2 are less likely to shift, and the insulation distance between the turns of the coil 2 is ensured. Furthermore, since the coil 2 is supported by the coil supporting portions 61, it is possible to prevent the insulating member 6 from being damaged due to movement of the coil 2 or the like.

Also, when an insulating coating is to be formed on the U-shaped members 21 and 22 and the I-shaped members 23, 24, and 25 having a thickness of 5mm or more, it is necessary to perform a work of forming the insulating coating after forming the U-shaped members 21 and 22 or the I-shaped members 23, 24, and 25, which results in an increase in cost. However, by using the insulating member 6 as in the present embodiment, it is possible, as compared with a case where an insulating coating is formed, to improve workability and reduce cost, and also to insulate the coil 2 from the mounting bracket 4 and support the coil 2.

The core 1 on which the coil 2 is mounted and the core case 3 that insulates the core 1 from the coil 2 are further included. The core case 3 includes a plurality of ribs 36 that extend so as to hold the turns of the coil 2 therebetween.

Accordingly, since the position of each turn of the coil 2 is more firmly restricted by the ribs 36, positional displacement between the turns of the coil 2 can be effectively suppressed. Also, since positional displacement of the turns of the coil 2 can be suppressed, it is possible to prevent the insulating member 6 from being damaged due to vibration of the coil 2, and insulation can be maintained over a long period. In particular, in the present embodiment, since the ribs 36 and each turn of the coil 2 are bonded with an adhesive, the effect of suppressing positional displacement can be made remarkable.

Also, since the ribs 36 also have an insulating function, insulation between the turns of the coil 2 can be achieved. Therefore, as compared with a case where the ribs 36 are not provided, a distance between the turns of the coil 2 can be shortened, and the coil component 10 can be reduced in size.

The U-shaped members 21 and 22 and the I-shaped members 23, 24, and 25 include fastening portions 26 connecting adjacent U-shaped members 21 and 22 and I-shaped members 23, 24, and 25. The coil component 10 further includes a resin cover 7 that surrounds the fastening portions 26. The resin cover 7 includes fastening-portion accommodating spaces 71 that, by a top plate 711 and a plurality of wall portions 712, surround, one by one, connection portions of adjacent U-shaped members 21 and 22 and I-shaped members 23, 24, and 25 connected by the fastening portions 26.

Accordingly, it is possible to achieve insulation at connection portions of the U-shaped members 21 and 22 and the I-shaped members 23, 24, and 25.

The resin cover 7 includes, in at least one of the wall portions 712, a coil insertion opening 72 through which the I-shaped members 23, 24, and 25 are inserted, and the coil insertion opening 72 is fitted with the I-shaped members 23, 24, and 25.

Accordingly, the coil 2 can also be supported by the coil insertion opening 72. Therefore, support of the coil 2 becomes firmer, position of each turn of the coil 2 become less likely to shift, an insulation distance between each turn of the coil 2 is ensured, and damage to the insulating member 6 can be prevented.

The installation target surface is a wall extending in a direction parallel with gravity, and, when the coil component 10 is fixed to the installation target surface, the winding-axis direction of the coil 2 is parallel with gravity. When the coil component 10 is arranged on the installation target object in this manner, each turn of the coil 2 is pulled downward by its own weight, so that the turns of the coil 2 may move, the insulation distance initially ensured may become shorter, and insulation may not be ensured. However, in the present embodiment, each turn of the coil 2 is fitted in and supported by the coil supporting portions 61 of the insulating member 6. Therefore, even when the coil component 10 is arranged in this manner, it is possible to maintain the insulation distance between each turn.

The rib 36 includes reinforcing portion 361 that extends orthogonally to an extending direction of the rib 36. Accordingly, strength of the rib 36 is increased. Therefore, even when the coil 2 is formed of thick members such that the U-shaped members 21 and 22 and the I-shaped members 23, 24, and 25 have a thickness of 8mm as in the present embodiment and the coil 2 is heavy, it is possible to prevent damage to the ribs 36. Accordingly, it is possible to maintain, over a long period, a positional-displacement suppression function and an insulating function of the ribs 36.

A fixing bracket 5 that fits with the core case 3 and is fixed to the mounting bracket 4 is further included, and the fixing bracket 5 includes a protruding portion 513 that protrudes toward the resin cover 7. The protruding portion 513 is in contact with the resin cover 7. Accordingly, even if the coil component 10 vibrates, a position of the resin cover 7 is restricted by the protruding portion 513. Therefore, it is possible to maintain insulation of the connection portions by the resin cover 7 and suppression of positional displacement of each turn of the coil 2.

The conductive members include the U-shaped members 21 and 22 and the I-shaped members 23, 24, and 25, and the coil 2 is formed by alternately connecting the U-shaped members 21 and 22 and the I-shaped members 23, 24, and 25.

Accordingly, by inserting the I-shaped members 23, 24, and 25 into the inside of the core 1 and inserting the leg portion 11 into the inside of the U-shaped members 21 and 22, the U-shaped members 21 and 22 and the I-shaped members 23, 24, and 25 can be fastened. Therefore, the coil 2 can be easily formed, and the coil 2 can be mounted on the leg portion 11, thereby improving productivity.

Also, the insulating member 6 includes a connecting portion 62 that connects coil supporting portions 61. That is, one insulating member 6 includes two coil supporting portions 61. Therefore, as compared with a case where the protruding portions 63 of the insulating member 6 are fitted one by one into the fitting holes 45 of the mounting bracket 4, assemblability is improved and production efficiency is good.

### Other Embodiment

In the description herein, although embodiments according to the present disclosure are described, said embodiments are only provided as examples and are not intended to limit the scope of claims. The above-described embodiments may be implemented by other various forms, and various omissions, replacements, and changes may be made without departing from the scope of claims. The embodiments and modifications thereof are included in the invention described in the claims and equivalent ranges thereto, as well as in the scope and abstract of the invention.

In the above embodiment, the size of the coil insertion opening 72 is the same as the thickness t of the I-shaped members 23, 24, and 25, but may be slightly larger than the thickness t of the I-shaped members 23, 24, and 25. Even when the size is slightly larger, even if the I-shaped members 23, 24, and 25 forming the coil 2 try to move, by coming into contact with the coil insertion opening 72, it is possible to obtain a certain positional-displacement suppression effect.

What is claimed is:

1. A coil component comprising:
a coil formed by connecting a plurality of conductive members each having a thickness of 5 mm or more;
a mounting bracket made of a metal member and fixing the coil component to an installation target surface; and
an insulating member disposed between the coil and the mounting bracket,
wherein the plurality of conductive members are not covered around their peripheries with an insulating coating,
the mounting bracket has a fitting hole formed therein, and
the insulating member includes:
a coil supporting portion into which each turn of the coil is inserted and that fits with each turn; and
a protruding portion that fits into the fitting hole and fixes the insulating member to the mounting bracket.

2. The coil component according to claim 1, further comprising:
a core on which the coil is mounted; and
a core case that insulates the core from the coil,
wherein the core case has a plurality of ribs extending to hold the turns of the coil therebetween.

3. The coil component according to claim 1,
wherein the conductive member has a fastening portion connecting to an adjacent conductive member,
the coil component further comprising a resin cover surrounding the fastening portion,
wherein the resin cover has a fastening-portion accommodating space surrounding a connection portion of adjacent conductive members connected by the fastening portion, the fastening-portion accommodating space being defined by a top plate and a plurality of wall portions.

4. The coil component according to claim 3,
wherein the resin cover includes a coil insertion opening in at least one of the wall portions, the conductive member being inserted through the coil insertion opening, and
the coil insertion opening fits with the conductive member.

5. The coil component according to claim 1,
the installation target surface is a wall extending in a direction parallel with gravity, and
when the coil component is fixed to the installation target surface, a winding-axis direction of the coil is parallel with gravity.
